(19) United States
(12) Patent Application Publication
(10) Pub. No.: US 2024/0160130 A1
(43) Pub. Date: May 16, 2024

(54) IMAGE FORMING APPARATUS

(71) Applicant: FUJIFILM Business Innovation Corp., Tokyo (JP)

(72) Inventors: Yoshiki SHIMODAIRA, Kanagawa (JP); Hideki Kuge, Kanagawa (JP); Takayuki Ukawa, Kanagawa (JP); Masato Yamashita, Kanagawa (JP)

(73) Assignee: FUJIFILM Business Innovation Corp., Tokyo (JP)

(21) Appl. No.: 18/321,423

(22) Filed: May 22, 2023

(30) Foreign Application Priority Data
Nov. 16, 2022 (JP) 2022-183597

(51) Int. Cl. G03G 15/20

(52) U.S. Cl. CPC G03G 15/2035; G03G 15/205

(57) ABSTRACT

An image forming apparatus includes a transport unit that transports a recording medium and that includes a grip portion that grips the recording medium on which a toner image is formed, and a movement unit that moves the grip portion; a heating unit that heats the recording medium that is transported by the transport unit; and a controller that exerts control such that the transport unit stops transport after the recording medium is retracted to a position downstream of the heating unit in a case where the transport unit stops the transport.

### CROSS-REFERENCE TO RELATED APPLICATIONS

This application is based on and claims priority under 35 USC 119 from Japanese Patent Application No. 2022-183597 filed Nov. 16, 2022.

### BACKGROUND

### (i) Technical Field

The present disclosure relates to an image forming apparatus.

### (ii) Related Art

A heating device disclosed in Japanese Unexamined Patent Application Publication No. 2022-024892 includes a heating unit that heats in a non-contact manner an upper surface of a transport material that is transported, and a blowing unit that blows air against a lower surface of the transport material via a blowing hole that is provided in an opposing surface opposing the lower surface of the transport material, the opposing surface being obliquely disposed with respect to a horizontal direction.

### SUMMARY

An existing image forming apparatus includes a transport unit that transports a recording medium and that includes a grip portion that grips the recording medium on which a toner image is formed and a movement unit that moves the grip portion. The image forming apparatus also includes a heating unit that heats the recording medium that is transported by the transport unit.

When an anomaly occurs, the image forming apparatus immediately stops transporting the recording medium. If transporting the recording medium is stopped with the recording medium heated by the heating unit, then the temperature of the recording medium becomes high.

Aspects of non-limiting embodiments of the present disclosure relate to the case where the temperature of a recording medium is inhibited from being high, unlike the case where transporting a recording medium is immediately stopped when an anomaly occurs in an image forming apparatus.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an image forming apparatus including a transport unit that transports a recording medium and that includes a grip portion that grips the recording medium on which a toner image is formed, and a movement unit that moves the grip portion; a heating unit that heats the recording medium that is transported by the transport unit; and a controller that exerts control such that the transport unit stops transport after the recording medium is retracted to a position downstream of the heating unit in a case where the transport unit stops the transport.

### BRIEF DESCRIPTION OF THE DRAWINGS

Exemplary embodiments of the present disclosure will be described in detail based on the following figures, wherein:

FIG. 1 illustrates the overall configuration of an image forming apparatus according to a first exemplary embodiment of the present disclosure;

FIG. 2 illustrates a toner image forming unit that is included in the image forming apparatus according to the first exemplary embodiment of the present disclosure;

FIG. 3 is a perspective view of a chain gripper that is included in the image forming apparatus according to the first exemplary embodiment of the present disclosure;

FIG. 4 illustrates a cooling portion that is included in the image forming apparatus according to the first exemplary embodiment of the present disclosure;

FIG. 5 is a front view of, for example, a fixing device that is included in the image forming apparatus according to the first exemplary embodiment of the present disclosure;

FIG. 6 is a front view of, for example, the fixing device that is included in the image forming apparatus according to the first exemplary embodiment of the present disclosure;

FIG. 7 is a side view of a pre-heat member that is included in the image forming apparatus according to the first exemplary embodiment of the present disclosure;

FIG. 8 is a perspective view of a heat member that is included in the image forming apparatus according to the first exemplary embodiment of the present disclosure;

FIG. 9 is a sectional view of the heat member that is included in the image forming apparatus according to the first exemplary embodiment of the present disclosure;

FIG. 10 is a plan view of a blower unit that is included in the image forming apparatus according to the first exemplary embodiment of the present disclosure;

FIG. 11 is a perspective view of, for example, a transfer roller that is included in the image forming apparatus according to the first exemplary embodiment of the present disclosure;

FIG. 12 is a diagram illustrating, for example, the hardware configuration of a controller according to the first exemplary embodiment of the present disclosure;

FIG. 13 illustrates a control flow with the controller that is included in the image forming apparatus according to the first exemplary embodiment of the present disclosure;

FIG. 14 is a sectional view of, for example, a transfer roller that is included in an image forming apparatus according to a second exemplary embodiment of the present disclosure; and

FIG. 15 is a sectional view of, for example, the transfer roller that is included in the image forming apparatus according to the second exemplary embodiment of the present disclosure.

### DETAILED DESCRIPTION

### First Exemplary Embodiment

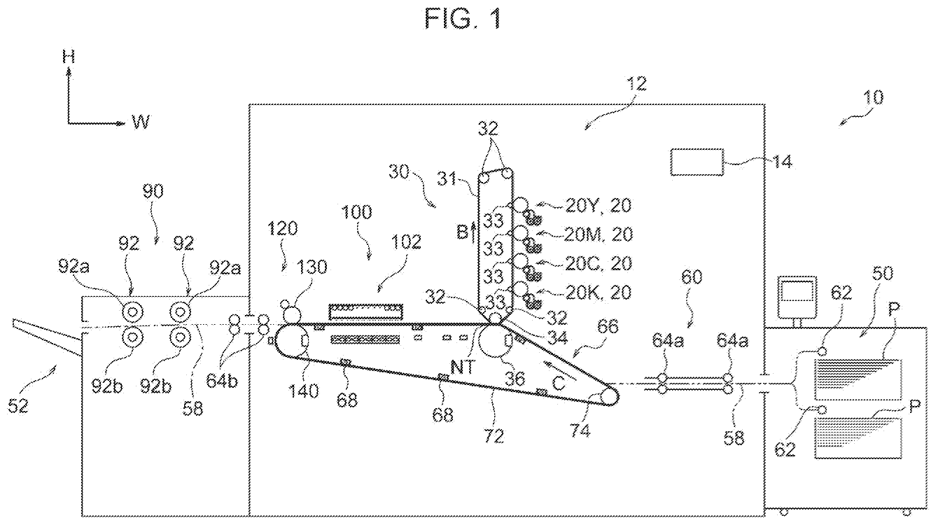

An image forming apparatus according to a first exemplary embodiment of the present disclosure will be described by way of example with reference to FIG. 1 to FIG. 13. In the figures, an arrow H represents an up-down direction of the apparatus (a vertical direction), an arrow W represents a width direction of the apparatus (a horizontal direction), and an arrow D represents a depth direction of the apparatus (a horizontal direction).

### Image Forming Apparatus 10

An image forming apparatus 10 according to the present exemplary embodiment is an electrophotographic image forming apparatus that forms toner images on a sheet material P corresponding to a recording medium. As illustrated in FIG. 1, the image forming apparatus 10 includes container units 50, a discharge portion 52, an image forming unit 12, a transport mechanism 60, a fixing device 100, a cooling portion 90, and a controller 14 that controls components.

### Container Units 50

The container units 50 are disposed at a side portion of the image forming apparatus 10 in the width direction and are arranged in the up-down direction, and the number thereof is two. The container units 50 contain the sheet materials P. Each sheet material P is selectively fed from the two container units 50.

### Discharge Portion 52

The discharge portion 52 is disposed at another side portion of the image forming apparatus 10 in the width direction, and the sheet material P on which the toner images are formed is discharged onto the discharge portion 52. Specifically, the toner images are fixed by the fixing device 100, and the sheet material P is subsequently cooled by the cooling portion 90 and is discharged onto the discharge portion 52.

### Image Forming Unit 12

The image forming unit 12 includes toner image forming units 20 that are disposed between the container units 50 and the discharge portion 52 in the width direction and that form the toner images and a transfer device 30 that transfers the toner images that are formed by the toner image forming units 20 to the sheet material P.

The multiple toner image forming units 20 form the toner images in colors. The image forming apparatus 10 includes the toner image forming units 20 for four colors of yellow (Y), magenta (M), cyan (C), and black (K) in total. Symbols of (Y), (M), (C), and (K) illustrated in FIG. 1 represent components for the respective colors described above. In the following description, Y, M, C, and K are omitted in some cases where Y, M, C, and K are not particularly distinguished.

### Toner Image Forming Units 20

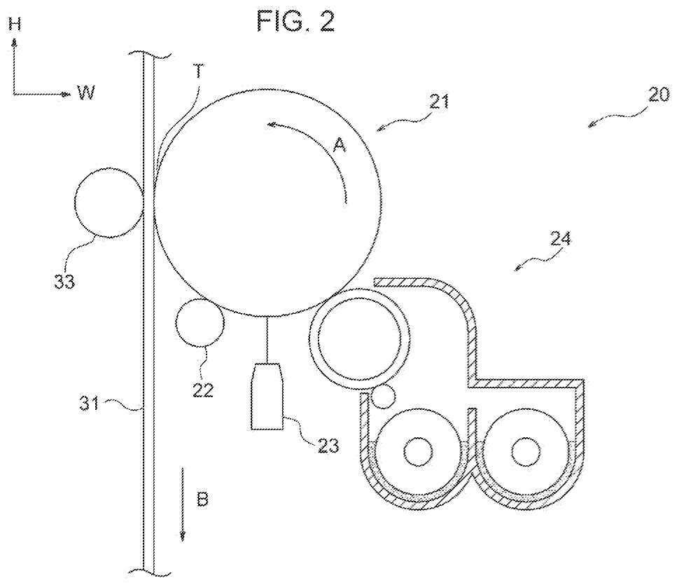

The toner image forming units 20 for the respective colors basically have the same structure except for toner to be used. Specifically, as illustrated in FIG. 2, the toner image forming units 20 for the respective colors include photoconductor drums 21 (photoconductor members) that rotate in the direction of an arrow A in the figure and chargers 22 that charge the photoconductor drums 21. The toner image forming units 20 for the respective colors also include exposure devices 23 that expose the photoconductor drums 21 charged by the chargers 22 to light and that form electrostatic latent images on the photoconductor drums 21 and developing devices 24 that use the toner to develop the electrostatic latent images that are formed on the photoconductor drums 21 by using the exposure devices 23.

### Transfer Device 30

As illustrated in FIG. 1, the transfer device 30 includes a transfer belt 31 that serves as an intermediate transfer body, first transfer rollers 33, a second transfer roller 34, and a facing roller 36.

The first transfer rollers 33 transfer the toner images that are formed on the photoconductor drums 21 to the transfer belt 31 at first transfer positions T (see FIG. 2) between the photoconductor drums 21 and the first transfer rollers 33.

The transfer belt 31 has no ends and is wound around multiple rollers 32 so as to have predetermined posture. At least one of the multiple rollers 32 is rotated, and the transfer belt 31 consequently turns in the direction of an arrow B and transports a first-transferred image to a second transfer position NT.

A part of the transfer belt 31 is wound around the second transfer roller 34. The facing roller 36 faces the second transfer roller 34 with the transfer belt 31 interposed therebetween.

Consequently, the second transfer roller 34 rotates along with the transfer belt 31 that turns, and the toner images on the transfer belt 31 are transferred to the sheet material P that is transported and that passes through the second transfer position NT with the sheet material P interposed between the facing roller 36 and the transfer belt 31 that rotate. The facing roller 36 is an example of a rotation member. The second transfer roller 34 is an example of a transfer member.

### Transport Mechanism 60

As illustrated in FIG. 1, the transport mechanism 60 includes feed rollers 62 that feed each sheet material P that is contained in the container units 50 to a path 58 for transporting the sheet material P, multiple transport rollers 64a and 64b that transport the sheet material P that is fed to the path 58 for transporting, and a chain gripper 66.

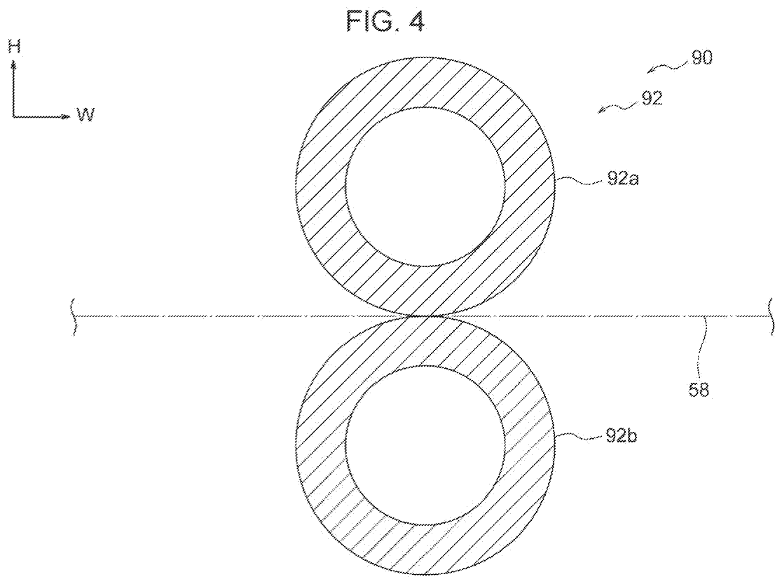

The multiple transport rollers 64a transport the sheet material P that is fed from the feed rollers 62 to the chain gripper 66. The multiple transport rollers 64b transport the sheet material P that is transported by the chain gripper 66 to the cooling portion 90 (see FIG. 4).

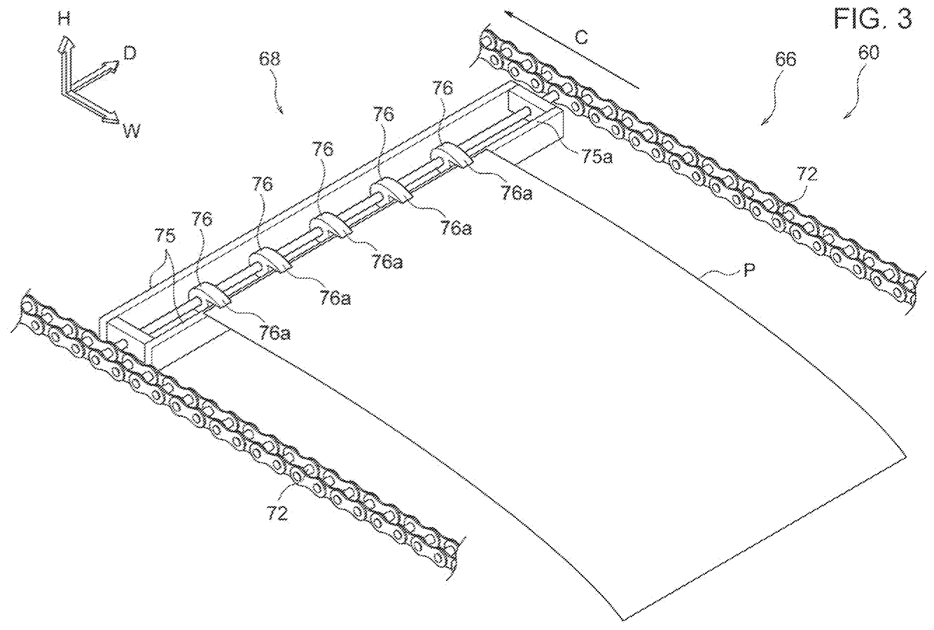

As illustrated in FIG. 3, the chain gripper 66 includes two chains 72 and holding members 68 that hold a leading edge portion of the sheet material P. The chains 72 and the holding members 68 that are included in the chain gripper 66 also function as components of the fixing device 100 and will be described later together with the fixing device 100.

### Fixing Device 100

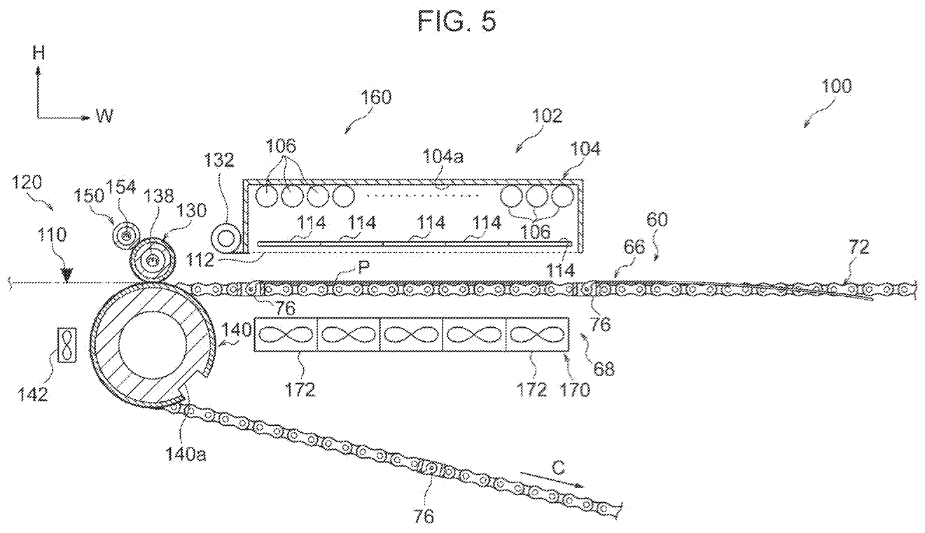

As illustrated in FIG. 5, the fixing device 100 includes the chain gripper 66 and a pre-heat member 102 that is disposed downstream of the transfer device 30 (see FIG. 1) in a direction in which the sheet material P is transported and that heats the transported sheet material P in a contactless manner. The fixing device 100 also includes a heat member 120 that comes into contact with the sheet material P and that heats and presses the sheet material P and a blower unit 170. A heating unit 160 includes the pre-heat member 102 and the heat member 120 and heats the sheet material P.

### Chain Gripper 66

As illustrated in FIG. 3, the chain gripper 66 includes the two chains 72 and the holding members 68 that hold the sheet material P. The chain gripper 66 is an example of a transport unit.

### Chains 72

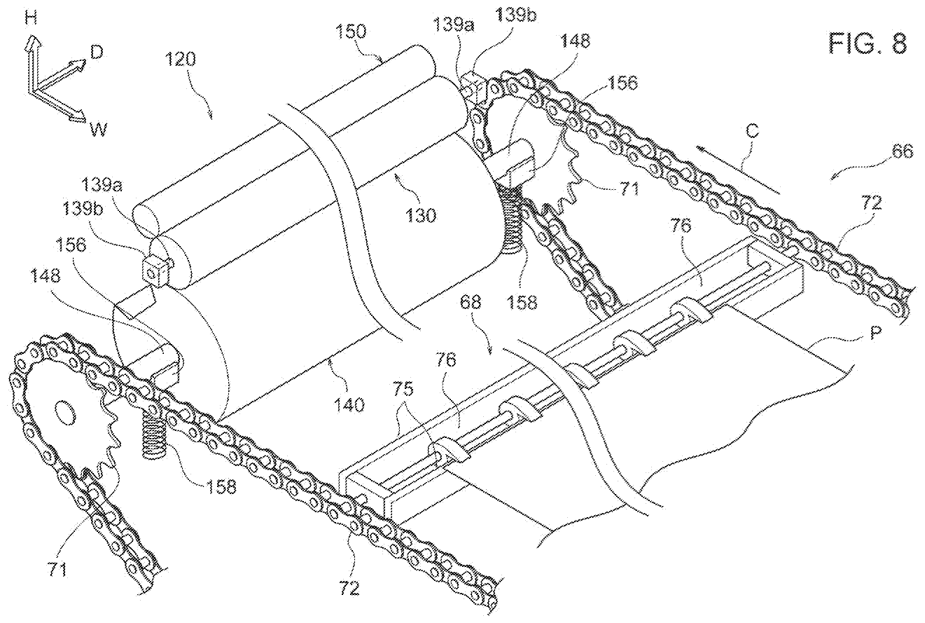

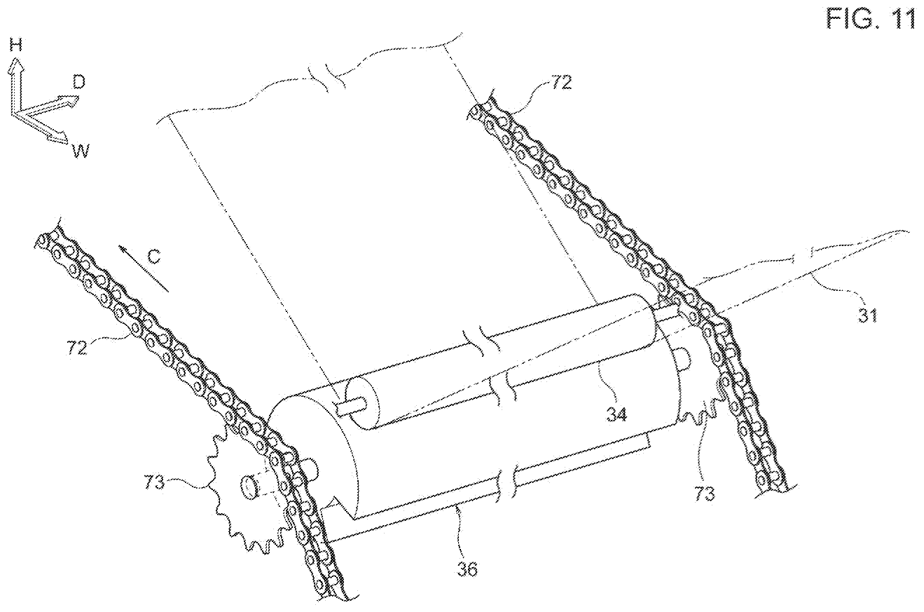

As illustrated in FIG. 3, the two chains 72 are separated from each other in the depth direction of the apparatus. As illustrated in FIG. 11, the two chains 72 are disposed at an end and another end of the facing roller 36 in an axial direction and are wound around two sprockets 73 the axial direction of which coincides with the depth direction of the apparatus, two sprockets 71 (see FIG. 8) that are disposed at an end and another end of a pressure roller 140 described later in an axial direction, and two sprockets 74 (see FIG. 1) that are arranged at an interval in the depth direction of the apparatus. Any one of the sprockets rotates, and consequently, the chains 72 turn in the direction of an arrow C.

Both end portions of each holding member 68 that holds the sheet material P are mounted on the two chains 72. The chains 72 are examples of a movement unit.

### Holding Members 68

As illustrated in FIG. 3, the holding members 68 have the end portions that are mounted on the two chains 72 and include mount members 75 that extend in the depth direction of the apparatus and grippers 76 that are mounted on the mount members 75. The multiple holding members 68 are arranged in a predetermined interval in a circumferential direction of the chains 72 (a turn direction). The holding members 68 are examples of a grip portion.

The multiple grippers 76 are mounted on the mount members 75 at a predetermined interval in the depth direction of the apparatus. Specifically, each gripper 76 includes a pawl 76a. Each mount member 75 includes a contact portion 75a with which the pawl 76a comes into contact. The gripper 76 grips the leading edge portion of the sheet material P by interposing the leading edge portion of the sheet material P between the pawl 76a and the contact portion 75a. As for the gripper 76, for example, the pawl 76a is pressed against the contact portion 75a by using, for example, a spring, and the pawl 76a comes into contact or is separated from the contact portion 75a by using, for example, a cam action.

With this structure, the chains 72 turn in the direction of the arrow C, the chain gripper 66 illustrated in FIG. 1 consequently receives the sheet material P that is transported by the transport rollers 64a, and the sheet material P is transported to the second transfer position NT with the leading edge of the sheet material P gripped. The chain gripper 66 transports the sheet material P to the heat member 120 after passing through the pre-heat member 102.

### Heat Member 120

As illustrated in FIG. 5, the heat member 120 is disposed downstream of the pre-heat member 102 in the direction in which the sheet material P is transported. The heat member 120 includes a heat roller 130 that heats the sheet material P with the heat roller 130 being in contact with the sheet material P that is transported, the pressure roller 140 that presses the sheet material P toward the heat roller 130, and a driven roller 150 that rotates in conjunction with the heat roller 130 that rotates.

### Heat Roller 130

As illustrated in FIG. 5, the heat roller 130 comes into contact with an upward facing surface of the sheet material P that is transported and extends in the depth direction of the apparatus, and the axial direction thereof coincides with the depth direction of the apparatus. The heat roller 130 contains a heater 138.

As illustrated in FIG. 8, shaft members 139a extend in the depth direction of the apparatus at both end portions of the heat roller 130 in the depth direction of the apparatus. Support members 139b that support the respective shaft members 139a are provided. Consequently, the heat roller 130 is rotatably supported by the support members 139b at both end portions of the heat roller 130.

### Driven Roller 150

As illustrated in FIG. 5 and FIG. 8, the driven roller 150 extends in the depth direction of the apparatus opposite the sheet material P that is transported with the heat roller 130 interposed therebetween, and the axial direction thereof coincides with the depth direction of the apparatus. The driven roller 150 contains a heater 154.

With this structure, the driven roller 150 rotates in conjunction with the heat roller 130. The driven roller 150 heats the heat roller 130.

### Pressure Roller 140

As illustrated in FIG. 8, the pressure roller 140 comes into contact with a downward facing surface of the sheet material P that is transported opposite the heat roller 130 with the sheet material P that is transported interposed therebetween and extends in the depth direction of the apparatus, and the axial direction thereof coincides with the depth direction of the apparatus. The pressure roller 140 includes two shaft members 148 that are formed at both end portions in the depth direction of the apparatus. The outer diameter of the pressure roller 140 is larger than the outer diameter of the heat roller.

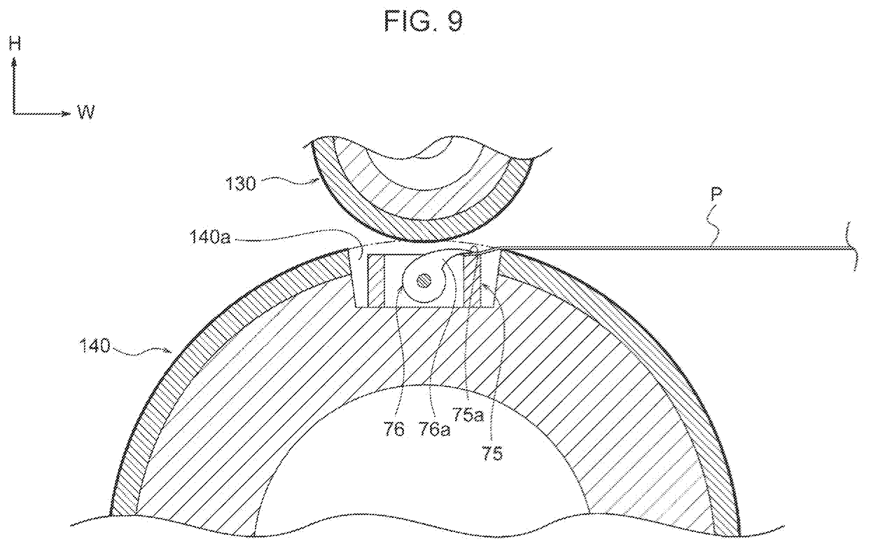

As illustrated in FIG. 9, a recessed portion 140a that extends in the depth direction of the apparatus is formed on an outer circumferential surface of the pressure roller 140. In the case where the sheet material P passes between the pressure roller 140 and the heat roller 130, the grippers 76 that grip the leading edge portion of the sheet material P are contained in the recessed portion 140a.

### Others

As illustrated in FIG. 8, the heat member 120 includes support members 156 that support the pressure roller 140 and urging members 158 that urge the pressure roller 140 toward the heat roller 130 with the support members 156 interposed therebetween. The support members 156 are paired. The paired support members 156 are disposed so as to be capable of rotatably supporting the two shaft members 148 of the pressure roller 140 from below.

As illustrated in FIG. 5, a sensor 110 that is an optical sensor that detects the sheet material P that is transported is disposed downstream of a contact portion between the heat roller 130 and the pressure roller 140 in the direction in which the sheet material P is transported.

A fan 142 faces the pressure roller 140 and cools the holding members 68 after the sheet material P is given to the transport rollers 64b (see FIG. 1).

With this structure, the two urging members 158 urge the pressure roller 140 toward the heat roller 130, and the pressure roller 140 consequently presses the sheet material P toward the heat roller 130. A drive member, not illustrated, transmits rotational force to the pressure roller 140, and the pressure roller 140 consequently rotates. The heat roller 130 rotates in conjunction with the pressure roller 140 that rotates. The driven roller 150 rotates in conjunction with the heat roller 130 that rotates. The heat roller 130 and the pressure roller 140 transport the sheet material P to which the toner images are transferred with the sheet material P interposed therebetween, and the toner images are consequently fixed to the sheet material P. The heat roller 130 and the pressure roller 140 thus transport the sheet material P while rotating with the sheet material P interposed therebetween, the sheet material P is heated, and the toner image are consequently fixed to the sheet material P.

### Pre-Heat Member 102

As illustrated in FIG. 5, the pre-heat member 102 is disposed downstream of the second transfer position NT (see FIG. 1) at which the toner images are transferred to the sheet material P and upstream of the heat member 120 in the direction in which the sheet material P is transported. The pre-heat member 102 is disposed above the sheet material P that is transported. In other words, the pre-heat member 102 faces the surface of the sheet material P that is transported to which the toner images are transferred.

The pre-heat member 102 includes a reflection member 104, multiple infrared heaters 106 (referred to below as “heaters 106”), heat plates 114, a wire net 112, and a shutter 132.

### Reflection Member 104

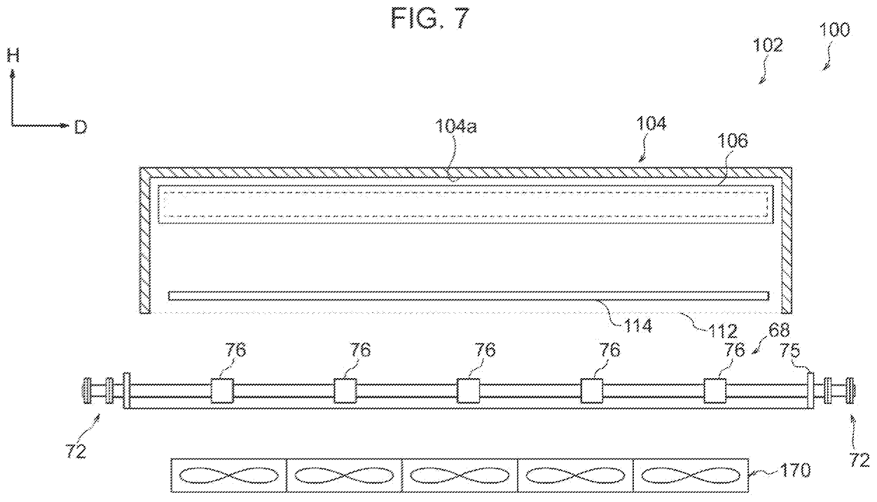

The reflection member 104 is composed of an aluminum plate and has a shallow box shape that opens toward the sheet material P that is transported. As illustrated in FIG. 7, the reflection member 104 contains the heat plates 114 and the heaters 106 in this order from the sheet material P that is transported. The reflection member 104 has a reflection surface 104a that reflects infrared rays that are heat rays emitted from the heaters 106 toward the heat plates 114.

### Heaters 106

The heaters 106 are infrared heaters that have a columnar shape, face the reflection surface 104a of the reflection member 104 in the up-down direction of the apparatus, and extend in the depth direction of the apparatus as illustrated in FIG. 7. As illustrated in FIG. 5, the multiple heaters 106 are arranged in the width direction of the apparatus.

### Heat Plates 114

As illustrated in FIG. 5, the multiple heat plates 114 are disposed between the chains 72 and the heaters 106 and are arranged in the width direction of the apparatus.

With this structure, the heat plates 114 absorb the infrared rays that are emitted from the heaters 106 and the infrared rays that are reflected by the reflection surface 104a. Consequently, the temperature thereof increases, and heat is dissipated. The heat plates 114 that have an increased temperature heat the sheet material P that is transported in a contactless manner.

### Wire Net 112

The wire net 112 is fixed to an edge of the reflection member 104 by using, for example, a fixation member, not illustrated, and separates an inner portion of the reflection member 104 from a portion outside the reflection member 104 as illustrated in FIG. 5. Consequently, the wire net 112 prevents the sheet material P that is transported and the heat plates 114 from coming into contact with each other.

### Shutter 132

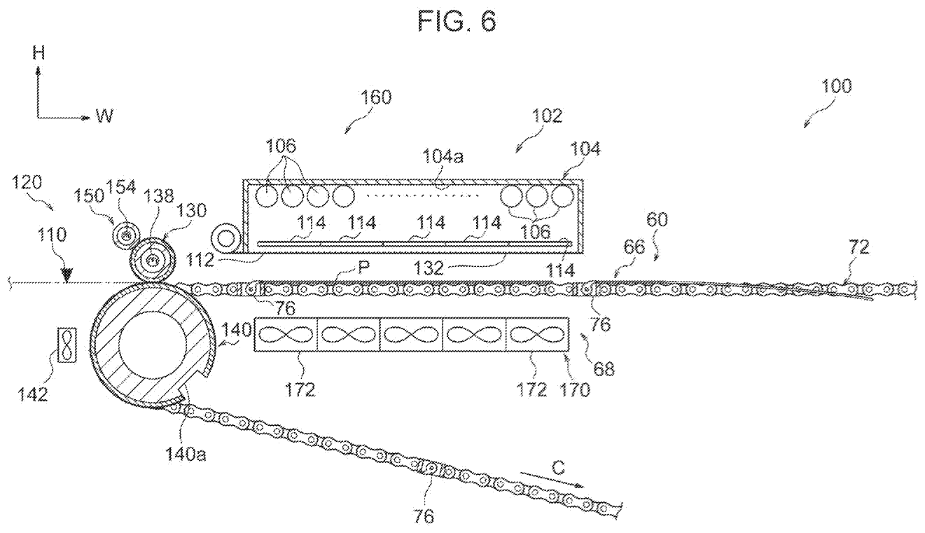

As illustrated in FIG. 5, the shutter 132 is adjacent to the reflection member 104 with the shutter 132 wound and covers the opening of the reflection member 104 with the shutter 132 unwound as illustrated in FIG. 6.

With this structure, the shutter 132 uncovers the opening of the reflection member 104 while the pre-heat member 102 is operating (see FIG. 5), and the shutter 132 covers the opening of the reflection member 104 while the pre-heat member 102 is not operating (see FIG. 6).

### Blower Unit 170

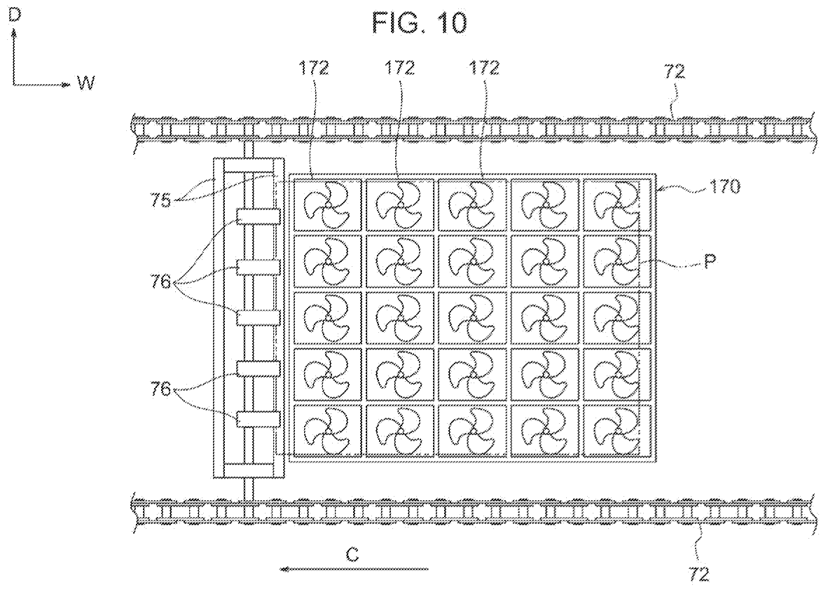

As illustrated in FIG. 5, the blower unit 170 faces the pre-heat member 102 in the up-down direction of the apparatus. The sheet material P that is transported passes between the blower unit 170 and the pre-heat member 102. As illustrated in FIG. 10, the blower unit 170 includes multiple fans 172 that are arranged in the width direction of the apparatus and in the depth direction of the apparatus.

With this structure, the multiple fans 172 blow air toward the sheet material P that is transported and stabilize the posture of the sheet material P that is transported.

### Cooling Portion 90

As illustrated in FIG. 1, the cooling portion 90 is disposed downstream of the fixing device 100 in the direction in which the sheet material P is transported. The cooling portion 90 includes two cooling rollers 92 that are arranged in the width direction of the apparatus. The two cooling rollers 92 have the same structure. Accordingly, one of the cooling rollers 92 will be described.

As illustrated in FIG. 4, the cooling roller 92 include a cooling roller 92a that is disposed above the path 58 for transporting the sheet material P and that is cylindrical and a cooling roller 92b that is disposed below the path 58 for transporting the sheet material P and that is cylindrical.

With this structure, an air-sending mechanism, not illustrated, causes air to flow through an inner portion of the cooling roller 92 that is cylindrical, and the temperature of the surface of the cooling roller 92 decreases. A drive member, not illustrated, transmits rotational force to the cooling roller 92b, and the cooling roller 92b consequently rotates. The cooling roller 92a rotates in conjunction with the cooling roller 92b. The cooling rollers 92a and 92b transport the sheet material P with the sheet material P interposed therebetween and cool the sheet material P.

### Actions

The actions of the image forming apparatus 10 will now be described.

The image forming apparatus 10 illustrated in FIG. 1 forms an image in the following manner.

The chargers 22 for the respective colors illustrated in FIG. 2 to which a voltage is applied negatively charge the surfaces of the photoconductor drums 21 for the respective colors uniformly with a predetermined potential. Subsequently, the exposure devices 23 radiate exposure light to the charged surfaces of the photoconductor drums 21 for the respective colors, based on image data that is inputted from the outside and form the electrostatic latent images.

Consequently, the electrostatic latent images depending on the image data are formed on the respective surfaces of the photoconductor drums 21. The developing devices 24 for the respective colors develop the electrostatic latent images as visible toner images. The first transfer rollers 33 of the transfer device 30 transfer the toner images that are formed on the surfaces of the photoconductor drums 21 for the respective colors to the transfer belt 31.

The sheet material P that is fed by the feed rollers 62 from one of the container units 50 illustrated in FIG. 1 to the path 58 for transporting and that is given to the chain gripper 66 from the transport rollers 64a is fed to the second transfer position NT at which the transfer belt 31 and the facing roller 36 are in contact with each other. Specifically, the grippers 76 grip the leading edge portion of the sheet material P, and the sheet material P is consequently given to the chain gripper 66 from the transport rollers 64a.

At the second transfer position NT, the sheet material P is interposed between the transfer belt 31 and the facing roller 36 and is transported, and the toner images on the surface of the transfer belt 31 are consequently transferred to the surface of the sheet material P.

The chains 72 that turn transport the sheet material P to which the toner images are transferred. The fans 172 illustrated in FIG. 5 operate, the fans 172 blow air to the sheet material P from below such that the surfaces of the sheet material P face in the up-down direction.

A voltage is applied to the heaters 106 of the pre-heat member 102. The heat plates 114 absorb the infrared rays that are emitted from the heaters 106 to which the voltage is applied and the infrared rays that are reflected by the reflection surface 104a. Consequently, the temperature thereof increases, and heat is dissipated. From above, the heat plates 114 that have an increased temperature heat the sheet material P that is transported by the chains 72 that turn in a contactless manner. The sheet material P is heated, and consequently, the toner for forming the toner images that are transferred to the sheet material P is softened.

As for the heat member 120, the heat roller 130 and the pressure roller 140 transport the sheet material P that is heated by the heat plates 114 of the pre-heat member 102 with the sheet material P interposed therebetween and fix the toner images to the sheet material P. The sheet material P to which the toner images are fixed is released from the grippers 76, is transported by the transport rollers 64b illustrated in FIG. 1, passes through the cooling portion 90, and is discharged onto the discharge portion 52.

### Controller 14

The controller 14 will now be described.

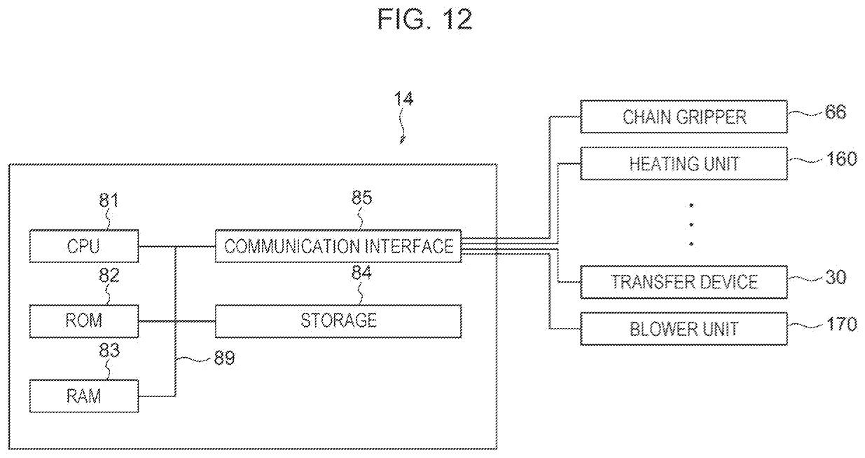

As illustrated in FIG. 12, the controller 14 includes a central processing unit (CPU) 81, a read only memory (ROM) 82, a random access memory (RAM) 83, a storage 84, and a communication interface (I/F) 85. These components are connected to each other by using a bus 89 so as to be capable of communicating with each other.

The CPU 81 is a central processing unit that runs various programs and controls components. That is, the CPU 81 reads a program from the ROM 82 or the storage 84 and runs the program with the RAM 83 used as a work area. The CPU 81 controls the components and performs various kinds of arithmetic processing in accordance with the program that is stored in the ROM 82 or the storage 84.

The ROM 82 stores the various programs and various kinds of data. The RAM 83 serves as the work area that temporarily stores a program or data. The storage 84 includes a hard disk drive (HDD) or a solid state drive (SSD) and stores the various programs including an operating system and the various kinds of data. The communication interface 85 is an interface for the controller 14 to communicate with, for example, the chain gripper 66, the heating unit 160, the transfer device 30, and the blower unit 170.

### Actions for Components

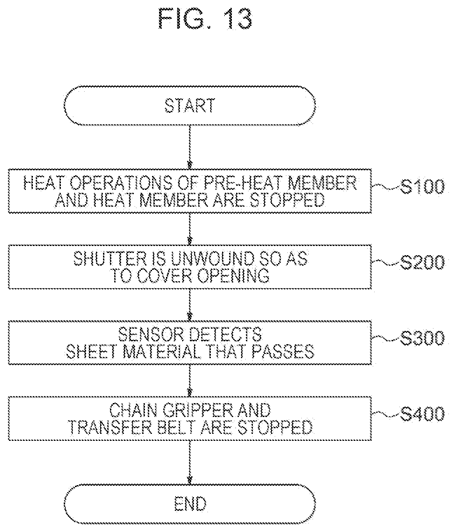

Among the actions for the components, the control of the components by using the controller 14 (see FIG. 1) in the case where an anomaly occurs in the image forming apparatus 10 will be described with reference to a flowchart in FIG. 13.

For example, when a sensor, not illustrated, detects, for example, a transfer failure or paper jam, the controller 14 stops image formation operations of the toner image forming units 20 for the respective colors, the feed rollers 62, and the transport rollers 64a.

After these are stopped, the controller 14 stops the heat operations of the pre-heat member 102 and the heat member 120 at a step S100. Specifically, the controller 14 stops the heaters 106 of the pre-heat member 102 illustrated in FIG. 5 and stops the heater 138 and the heater 154 of the heat member 120. The controller 14 does not stop the fans 172 of the blower unit 170.

At a step S200, the controller 14 causes the shutter 132 that uncovers the opening of the reflection member 104 to operate, and the shutter 132 is unwound such that the shutter 132 covers the opening of the reflection member 104 (see FIG. 5 and FIG. 6).

At a step S300, the sensor 110 illustrated in FIG. 5 detects the sheet material P that is transported by the chains 72 that turn, that is released from the grippers 76, that is retracted from the heating unit 160, and that passes.

At a step S400, the controller 14 that receives a detection signal from the sensor 110 stops the chain gripper 66, the second transfer roller 34, the transfer belt 31, and the transport rollers 64b. This is the end of a series of operations.

### SUMMARY

As for the image forming apparatus 10, the controller 14 controls the chain gripper 66 such that the sheet material P is retracted from the heating unit 160 in the case where an anomaly occurs in the image forming apparatus 10, and the transport rollers 64a stop as described above.

As for the image forming apparatus 10, the controller 14 stops the chain gripper 66, the second transfer roller 34, and the transfer belt 31 after the sheet material P is retracted from the heating unit 160. In this way, friction between the facing roller 36 and the second transfer roller 34 may be reduced, unlike the case where only the chain gripper 66 is stopped. Specifically, friction that acts on the transfer belt 31 between the facing roller 36 and the second transfer roller 34 may be reduced.

As for the image forming apparatus 10, the controller 14 stops the chain gripper 66 after the heat operation of the heat member 120 is stopped.

As for the image forming apparatus 10, the controller 14 stops the chain gripper 66 after the heat operation of the pre-heat member 102 is stopped.

### Second Exemplary Embodiment

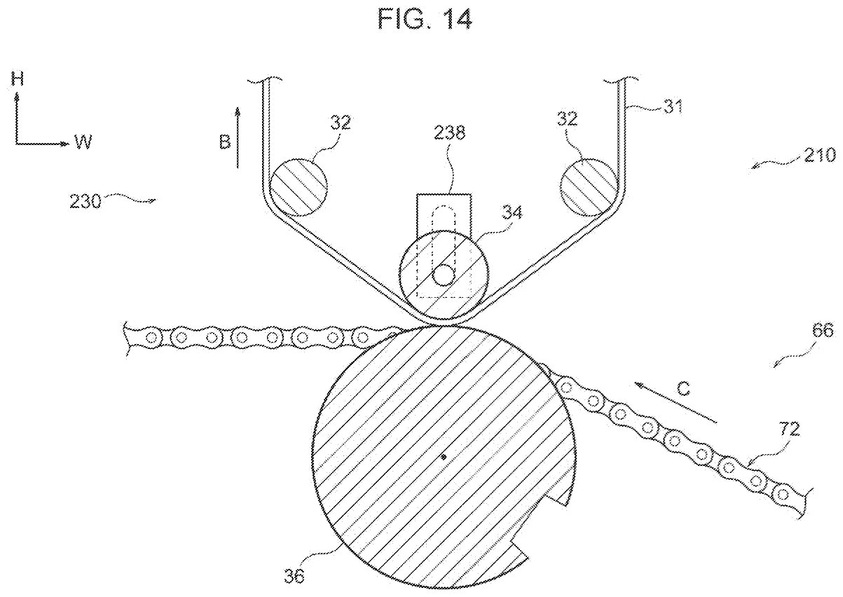

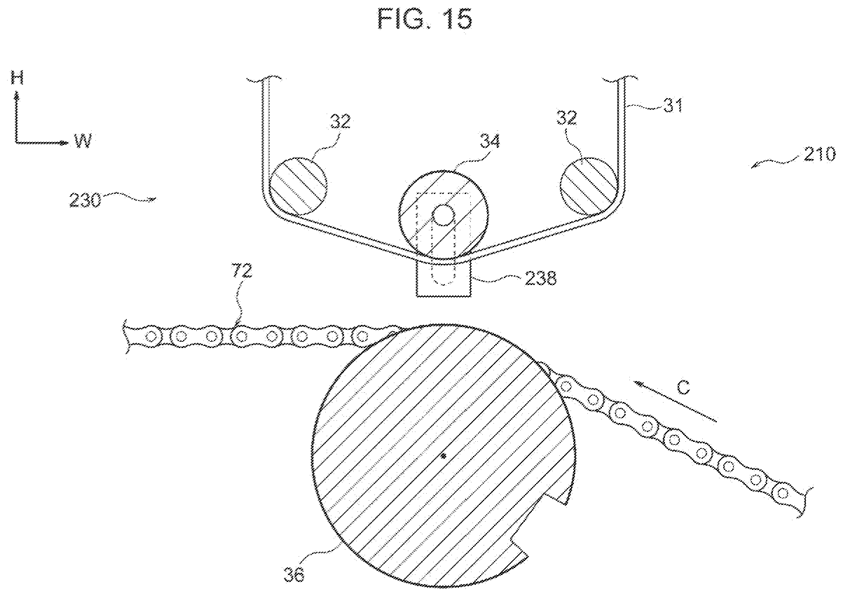

An image forming apparatus according to a second exemplary embodiment of the present disclosure will be described by way of example with reference to FIG. 14 and FIG. 15. According to the second exemplary embodiment, differences from the first exemplary embodiment will be described.

As illustrated in FIG. 14 and FIG. 15, a transfer device 230 of an image forming apparatus 210 according to the second exemplary embodiment includes a movement device 238 that rotatably supports the second transfer roller 34 and moves the second transfer roller 34 in the up-down direction.

The movement device 238 includes a known mechanism and moves the second transfer roller 34 between a position of contact (see FIG. 14) at which the second transfer roller 34 is adjacent to the facing roller 36 with the transfer belt 31 interposed therebetween and a position of separation (see FIG. 15) at which the second transfer roller 34 is separated from the facing roller 36.

With this structure, the controller 14 causes the second transfer roller 34 located at the position of contact to move to the position of separation in the case where the transport rollers 64a stop. In other words, the second transfer roller 34 located at the position of contact is moved to the position of separation before the chain gripper 66 is stopped. In this way, friction between the facing roller 36 and the second transfer roller 34 may be reduced, unlike the case where the second transfer roller located at the position of contact is moved to the position of separation after the chain gripper 66 is stopped. Specifically, friction that acts on the transfer belt 31 between the facing roller 36 and the second transfer roller 34 may be reduced.

The controller 14 stops the second transfer roller 34 and the transfer belt 31 after the second transfer roller 34 located at the position of contact is moved to the position of separation. In this way, energy consumption may be reduced, unlike the case where neither the second transfer roller nor the transfer belt is stopped after the second transfer roller 34 is moved to the position of separation.

The specific exemplary embodiments of the present disclosure are described in detail. The present disclosure, however, is not limited to the exemplary embodiments, and it is obvious for a person skilled in the art that various other exemplary embodiments may be in the range of the present disclosure. For example, the controller 14 may stop the fan 142 after the holding members 68 that give the sheet material P to the transport rollers 64b pass through a position facing the fan 142, although this is not particularly described according to the exemplary embodiments described above. Consequently, the temperature of the holding members 68 decreases, unlike the case where the fan 142 is stopped before the holding members 68 pass through the position facing the fan 142.

According to the exemplary embodiments described above, the toner images that are transferred to the transfer belt 31 are transferred to the sheet material P. In an example, however, the toner images that are formed on the photoconductor drums may be directly transferred to the sheet material P.

According to the exemplary embodiments described above, the controller 14 stops the chain gripper 66, the second transfer roller 34, and the transfer belt 31 after the sheet material P is retracted from the heating unit 160. However, the chain gripper, the second transfer roller, and the transfer belt may not be stopped. In this case, however, the actions that are taken by stopping the chain gripper 66, the second transfer roller 34, and the transfer belt 31 are not taken.

According to the second exemplary embodiment described above, the controller 14 stops the second transfer roller 34 and the transfer belt 31 after the second transfer roller 34 located at the position of contact is moved to the position of separation. However, neither the second transfer roller nor the transfer belt may be stopped. In this case, the actions that are taken by stopping the second transfer roller and the transfer belt are not taken.

According to the exemplary embodiments described above, the heating unit 160 includes the pre-heat member 102 but may not include the pre-heat member.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### Appendix

(((1)))

An image forming apparatus includes a transport unit that transports a recording medium and that includes a grip portion that grips the recording medium on which a toner image is formed, and a movement unit that moves the grip portion; a heating unit that heats the recording medium that is transported by the transport unit; and a controller that exerts control such that the transport unit stops transport after the recording medium is retracted to a position downstream of the heating unit in a case where the transport unit stops the transport.

(((2)))

The image forming apparatus described in (((1))) further includes a rotation member that is disposed upstream of the heating unit in a direction in which the recording medium is transported and that rotates along with movement of the movement unit; and a transfer member that transfers the toner image to the recording medium while rotating with the recording medium interposed between the transfer member and the rotation member. The controller exerts control such that the transport of the transport unit and rotation of the transfer member are stopped after the recording medium is retracted to the position downstream of the heating unit.

(((3)))

The image forming apparatus described in (((1))) further includes a rotation member that is disposed upstream of the heating unit in a direction in which the recording medium is transported and that rotates along with movement of the movement unit; and a transfer member that transfers the toner image to the recording medium while rotating with the recording medium interposed between the transfer member and the rotation member. The controller exerts control such that the transfer member is separated from the rotation member before the transport of the transport unit is stopped.

(((4)))

As for the image forming apparatus described in (((3))), the controller exerts control such that the transfer member that rotates is stopped after the transfer member is separated from the rotation member.

(((5)))

As for the image forming apparatus described in any one of (((1))) to (((4))), the heating unit includes a heat member that rotates and transports the recording medium with the recording medium interposed therein and that heats the recording medium, and the controller exerts control such that the transport unit is stopped after a heat operation of the heat member is stopped.

(((6)))

As for the image forming apparatus described in (((5))), the heating unit includes a pre-heat member that is disposed upstream of the heat member and that heats the recording medium that is transported in a contactless manner, and the controller exerts control such that the transport unit is stopped after a heat operation of the pre-heat member is stopped.

What is claimed is:

1. An image forming apparatus comprising:
a transport unit that transports a recording medium and that includes a grip portion that grips the recording medium on which a toner image is formed, and a movement unit that moves the grip portion;
a heating unit that heats the recording medium that is transported by the transport unit; and
a controller that exerts control such that the transport unit stops transport after the recording medium is retracted to a position downstream of the heating unit in a case where the transport unit stops the transport.

2. The image forming apparatus according to claim 1, further comprising:
a rotation member that is disposed upstream of the heating unit in a direction in which the recording medium is transported and that rotates along with movement of the movement unit; and
a transfer member that transfers the toner image to the recording medium while rotating with the recording medium interposed between the transfer member and the rotation member,
wherein the controller exerts control such that the transport of the transport unit and rotation of the transfer member are stopped after the recording medium is retracted to the position downstream of the heating unit.

3. The image forming apparatus according to claim 1, further comprising:
a rotation member that is disposed upstream of the heating unit in a direction in which the recording medium is transported and that rotates along with movement of the movement unit; and
a transfer member that transfers the toner image to the recording medium while rotating with the recording medium interposed between the transfer member and the rotation member,
wherein the controller exerts control such that the transfer member is separated from the rotation member before the transport of the transport unit is stopped.

4. The image forming apparatus according to claim 3,
wherein the controller exerts control such that the transfer member that rotates is stopped after the transfer member is separated from the rotation member.

5. The image forming apparatus according to claim 1,
wherein the heating unit includes a heat member that rotates and transports the recording medium with the recording medium interposed therein and that heats the recording medium, and
wherein the controller exerts control such that the transport unit is stopped after a heat operation of the heat member is stopped.

6. The image forming apparatus according to claim 5,
wherein the heating unit includes a pre-heat member that is disposed upstream of the heat member and that heats the recording medium that is transported in a contactless manner, and
wherein the controller exerts control such that the transport unit is stopped after a heat operation of the pre-heat member is stopped.

7. An image forming apparatus comprising:
transporting means for transporting a recording medium, for griping the recording medium on which a toner image is formed, and for moving the grip portion;
heating means for heating the recording medium that is transported by the transporting means; and
means for exerting control such that the transporting means stops transport after the recording medium is retracted to a position downstream of the heating means in a case where the transporting means stops the transport.
